(19) United States
(12) Patent Application Publication
(10) Pub. No.: US 2019/0133363 A1
(43) Pub. Date: May 9, 2019

(54) EXTENDIBLE COLLECTION APPARATUS

(71) Applicant: Clinton Graeme Burchat, Idalia, Queensland (AU)

(72) Inventor: Clinton Graeme BURCHAT, Idalia (AU)

(21) Appl. No.: 16/094,423

(22) PCT Filed: Jun. 26, 2017
(86) PCT No.: PCT/AU2017/050651

§ 371 Date: Oct. 17, 2018

(30) Foreign Application Priority Data
Jun. 28, 2016 (AU) 2016902520

(51) Int. Cl. A47G 29/28; A47G 29/14; B64C 39/02; B65G 11/02

(52) U.S. Cl. CPC A47G 29/28; A47G 29/141; G05D 1/0094; B65G 11/023; A47G 2029/146; B64C 39/024

(57) ABSTRACT

The invention relates to a collection device for items delivered by UAV including a receptacle adapted to receive the goods delivered by the UAV. The collection device also includes an extension means, adapted to extend the receptacle towards the UAV as it approaches. So as the UAV approaches the collection device for delivery of an item, the extension means approaches the UAV such that delivery is facilitated. The invention also relates to variants thereof. The invention also relates to methods of use of a collection device.

### FIELD OF THE INVENTION

The present invention relates to an extendible collection apparatus for items delivered by drone or Unmanned Aerial Vehicle (“UAV”).

### BACKGROUND OF THE INVENTION

A number of UAV or “drone” delivery methods are being developed around the world for purchased goods. Many of these utilises a system of dropping an item, either on the ground, or to a person waiting below. Each of these systems requires that the person be present to collect their item. Items delivered by UAV will in the most part be lightweight items ordered online. In cities these deliveries may be within a few hours, a vast improvement on conventional delivery systems.

However, the actual point of delivery for these existing drone delivery systems, where the item is simply dropped, is problematic. There are safety issues for people on the ground, as well as security issues and issues for the integrity of the item, particularly if it is an item that may be easily damaged. The inventor has developed a secure means of delivery, that enables delivery, securely without the need for the person to be home, subject of PCT/AU2015/000553 BURCHAT, the contents of which is incorporated herein by reference. In the international patent application use of locating means and identification means communicates between the UAV and the specific receptacle where the item is to be delivered. The invention enables verification that the receptacle is the correct receptacle for delivery, alignment above the receptacle and for a soft delivery therein.

The invention is subject of Australian provisional patent application No. 2016902520, the contents of which is also incorporated herein by reference. The subject invention is a further development to enable use of a retractable collection part, to extend away from the building as the UAV approaches, on a signal therefrom. In this way the item is delivered away from the building. To deliver close to the building may be difficult and lead to safety issues, or perceived issues by building owners. Use of the retracting apparatus enables the delivery of the item to take place slightly away from the building but still be received securely inside the building. Through use of the extendible arrangement in the illustrative examples, the item can be aligned with the opening through use of the inventor's novel alignment system. The package is then received and passed along into the building where it can be kept safe until the person is ready to retrieve the item, or kept in the net or container itself until ready for retrieval.

The following describes non-limiting examples of the invention being used with reference to a quadcopter style drone. Clearly, the invention may be used with any flying delivery method, and any form of UAV, flying delivery vehicle, manned or unmanned, or drone. In fact, it may be possible to use the invention with manned aerial vehicles as well, and so it is not intended that the invention be limited with respect to the nature of the vehicle, other than as limited in the claims.

Further, the form of extension or receptacle may be varied somewhat from the form as disclosed. It is not intended that the form of extension or receptacle be limited in any way, other than as defined in the claims.

For clarity, any prior art referred to herein, does not constitute an admission that the prior art forms part of the common general knowledge, in Australia or elsewhere.

It is an object of the present invention to provide an extendible collection means that at least ameliorates one or more of the aforementioned problems of the prior art. It is a further object of the invention to provide a method of use of an extendible collection means.

### DISCLOSURE OF THE INVENTION

Accordingly, the present invention provides a collection device for items delivered by UAV, the collection device including:
a receptacle adapted to receive goods delivered by the UAV;
an extension means, adapted to extend the receptacle towards the UAV as it approaches;
   wherein, as the UAV approaches the collection device for delivery of an item, the extension means approaches the UAV such that delivery is facilitated.

Accordingly, the present invention provides in a variant, a collection device for items delivered by UAV the collection device including:
an extension means, adapted to extend towards the UAV as it approaches, wherein, as the UAV approaches the collection device for delivery of an item, the extension means approaches the UAV to collect the item.

Preferably, the UAV (unmanned aerial vehicle) is any suitable unmanned aerial vehicle. The UAV may be of a form known as a QUADCOPTER (Trade Mark). The UAV may be known as a drone or similar. Preferably, the UAV includes a power source. Preferably, the UAV includes one or more motor to enable movement, powered by the power source. The UAV preferably includes a control unit and it is the control unit that controls movement of the UAV. Preferably, the control unit may receive external signals to control the UAV. The control unit may be connected to a mobile or other wireless network. Preferably, the control unit can receive address and delivery information through the wireless or mobile network. Preferably, Global Positioning System “GPS” locations can be provided to the control unit to cause movement of the UAV to the GPS location. The GPS location preferably is predetermined at the point of arrangement of the delivery, eg at the time of ordering the item online. Preferably, the UAV includes a sensor and the sensor can “see” so as to be used in verification and locating steps during delivery. The UAV may include a bar code reader. The UAV may include means to detect RFID, WIFI (Trade Mark), BLUETOOTH (Trade Mark) or similar devices.

The UAV may include sensors and detectors suitable to verify, locate or align with the extendible apparatus. Preferably, the UAV is used with the extendible collection apparatus of the invention but may be provided with the apparatus of the invention eg sold together as a unitary system.

The building may be any suitable building. The building may be a domestic building. The building may be an office building. The building may be an apartment block. The building may be a high rise building with a plurality of addresses for delivery of the goods. The building may be chosen from the group: domestic abode; commercial building; apartment block; office block; retail space; industrial building; outside location; or shed.

Preferably the receptacle is adapted to receive goods ordered online. The receptacle may take any suitable form. The receptacle may include a tray. The receptacle may be a box. The receptacle may take any suitable form for a package or box to be received therein. The receptacle may be chosen from the following group: funnel; tray; box; basket; or net. The receptacle may be the part of the apparatus that first collects the item. Other receptacles may be included in the apparatus. Other receptacles may be included to receive an item temporarily. Other receptacles may ultimately recept the item.

A secure container may be included, in which the item is stored after delivery until collection. The secure container may be extendible. The secure container may form part of the receptacle. The secure container may be fixed in place. The secured container may be outside of the building. The secured container may be inside the building. The security may be any suitable lock. The security may include an electronic lock. The electronic lock may be controlled by use of a mobile phone. Security software may be used. A pin or card access may be used to securely access the inside of the secure container and retrieve the item.

The receptacle may include a funnel. Preferably, the funnel includes an opening and the goods pass under gravity towards the opening during delivery. Preferably, the funnel is collapsible. Preferably, the funnel is made of a soft material. Preferably, the funnel is moveable between an open and a closed state. The funnel may lie vertical against the wall in the retracted state and extend out to receive an item, to lie substantially horizontal. The funnel may open out like a flower or umbrella form from a retracted to an open state. The funnel may unfold or unfurl during extension. The funnel may, in other forms be stored in a partially open state.

A tube arrangement may be included to assist to move the item from the point of receipt to a collection point. The collection point may be a secure container. The tube arrangement may extend. The tube arrangement may be fixed. Preferably, the tube arrangement assists to pass the item from the receptacle towards the building. The tube arrangement may take any suitable form.

Preferably, one or more brackets are included and these are moveable between an open and closed state on actuation by a signal from the control unit of the UAV. Alternatively, the signal may be sent or received internally or via the mobile phone or other wireless network. The signal to open or close the funnel may be sent in any suitable manner. Preferably, the bracket is a spring under tension in the closed state. Preferably, on activation the spring is released to extend out from the building. Any suitable manner of retraction of the spring may be used. A motor and wire may be used to wind in the extended part. Other forms of retraction and extension may be used instead. The bracket may be replaced by a motorised arm or other form of extension in other forms of the invention. A motorised arm or other actuated movement between an open and closed state may be used to extend and retract the receptacle.

Preferably, the funnel is adapted to be closed when not in use and to be opened when the UAV approaches ready to receive the goods. Preferably, the funnel assists in capture and delivery of the goods. The unfurling of the funnel may be used to assist to capture goods. Where the funnel is substantially vertical in the retracted state the funnel extends and swivels to be substantially horizontal in the extended state. The funnel may be varied somewhat to take other forms, and extend in other ways.

The receptacle may be a tray. The tray may take any suitable form. The tray may be extendible from the building to receive the goods. Preferably, the tray is stored away when not in use. Preferably, the tray extends out away from the building for receipt of the goods. Preferably, a signal from the UAV causes the tray to extend out. Preferably, the tray only extends out shortly before delivery.

Preferably, identity means are included. Preferably, the identity means identify the specific apparatus for delivery. Preferably, the receptacle include identity means. In this way the address of the order can be verified, before the delivery proceeds further. The identity tags may take any suitable form. The identity tags may be chosen from the group: bar codes; lights; LEDs; RFIDs; BLUETOOTH (Trade Mark) or other signally devices. Use of the identity tags ensure a verification step before the delivery proceeds further. Security, such as encryption may be used. The mobile phone network and internet may be used to verify the correct apparatus for delivery at any suitable point though delivery. Any suitable means of identification may be use. The identification step may be omitted in other forms of the invention. However, inclusion of the identification step is particularly useful.

Preferably, location means are included. The location means may take any suitable form. Preferably, the location means are included on or about the receptacle. Preferably, the location means are included on the receptacle. Preferably, the locating means define a specific shape, a location for recept of the goods. Preferably, the location means are chosen from the following group: RFIDs; LEDs; sounds; and or light sequences. The location means can take any suitable form that can communicate with the control unit to assist to locate and align the UAV for delivery of the goods.

The extension means may take any suitable form. The extension means preferably moves from a first state to a second state on receipt of a signal where the second state enables collection of the goods. Preferably, the extension means moves from a retracted state, close to the building to an extended state, moved away from the building, suitable to receive goods from the UAV. The extension may be in the horizontal plane. The extension may be in the vertical plane, in alternate forms of the invention. The extension may move from the vertical plane in the retracted form to the horizontal plane in the extended state. Any suitable combinations of vertical and horizontal plane moves may be used to extend. The extension may rotate through 90 degrees in some forms of the invention from a vertical to horizontal plane.

The extension means may include one or more bracket and it is the bracket that extends. Other forms may include long or short brackets, suitable to the building and use of the invention.

Preferably, as the UAV approaches the building the extension means is caused to extend from the building. The extension means may extend straight-out. The extension means may extend straight out, or rotate or in any suitable means.

Accordingly, the present invention, in a variant, provides a collection apparatus for items delivered by UAV, the collection device being associated with a building and including:
a receptacle adapted to receive goods delivered by the UAV;
an extension means, connected to the building and adapted to extend the receptacle from the building towards the UAV;
   wherein, the apparatus can remain proximal to the building when not in use and extend toward the UAV to facilitate delivery of the item.

Accordingly, the present invention also provides a method of use of an extendible collection device including a receptacle adapted to receive goods delivered by UAV, and an extension means, connected to the building at the delivery address and adapted to extend the receptacle from the building towards the UAV for UAV delivered goods, the method including the following steps:—
a) Moving the UAV to the general location of the delivery address;
b) Identifying the receptacle is the correct address for delivery;
c) Extending the receptacle away from the building;
d) Locating the extended receptacle;
e) Aligning the UAV directly above the receptacle;
f) Releasing the package.

The order of the steps may be varied. Further steps may be included including retrieving the goods from a secured area.

### INDUSTRIAL APPLICABILITY

It will be apparent to a person skilled in the art that changes may be made to the embodiments disclosed herein without departing from the spirit and scope of the invention in its various aspects.

### BRIEF DESCRIPTION OF THE DRAWINGS

The invention will now be described in connection with non-limiting preferred embodiments with reference to the accompanying drawings, in which:

FIG. 1 is a perspective view the front of a building showing delivering of a package through use of a UAV and showing an extendible collection apparatus according to a first preferred embodiment of the invention, in the extended state;

FIG. 2 is the detailed perspective view of the delivery of FIG. 1;

FIG. 3 is a perspective view of the apparatus of FIGS. 1 and 2, shown before the UAV arrives, with the extension means close to the building;

FIG. 4 is a front view of the apparatus of FIG. 3;

FIG. 5 is a side view of the extendible collection apparatus and UAV of FIGS. 3 and 4;

FIG. 6 is a front view of the apparatus of FIG. 4, with the funnel in the semi-opened state, as the UAV is getting closer to the point of delivery;

FIG. 7 is a side view of the semi-opened extendible collection apparatus and UAV of FIG. 5, as the UAV is getting closer;

FIG. 8 is a side view of the apparatus of FIG. 6, with the funnel in the nearly opened state, as the UAV approaches above the funnel;

FIG. 9 is a front view of the nearly opened extendible collection apparatus of FIGS. 1 to 8 with the UAV overhead holding the package;

FIG. 10 is a front view of the apparatus of FIG. 9, with the funnel fully extended and open, with the UAV directly above and the package being released;

FIG. 11 is the side view of the fully extended and open apparatus of FIG. 10;

FIG. 12 is a perspective view the front of a building showing delivering of a package through use of a UAV and showing an extendible collection apparatus, according to a second preferred embodiment of the invention;

FIG. 12a is a view from above through line A-A of FIG. 12, illustrating the location means and alignment in particular;

FIG. 13 is a view of the window of FIGS. 12 and 12a with the extendible collection apparatus in a closed state;

FIG. 14 is a side view of the apparatus of FIG. 12, 12a in the open state;

FIG. 15 is a perspective view of the extendible collection apparatus of FIG. 14;

FIG. 16 is a front view of the window of the extendible collection apparatus of FIG. 13, in the closed state;

FIG. 17 is the internal side view of the extendible collection apparatus of FIG. 16 in the closed state;

FIG. 18 is a front view of the window of the extendible collection apparatus of FIGS. 16 and 17, as the extension commences;

FIG. 19 is the internal side view of the extendible collection apparatus of FIG. 18, as the extension commences;

FIG. 20 is a front view of the window of the extendible collection apparatus of FIGS. 18 and 19, as the extension continues and the UAV approaches;

FIG. 21 is the internal side view of the extendible collection apparatus of FIG. 20, as the extension continues and the UAV approaches;

FIG. 22 is a front view of the window of the extendible collection apparatus of FIGS. 20 and 21, in the fully extended state as the UAV lowers; and

FIG. 23 is the internal side view of the extendible collection apparatus of FIG. 22, in the fully extended state as the UAV lowers ready to deliver the package.

### DETAILED DESCRIPTION OF THE INVENTION INCLUDING A BEST MODE

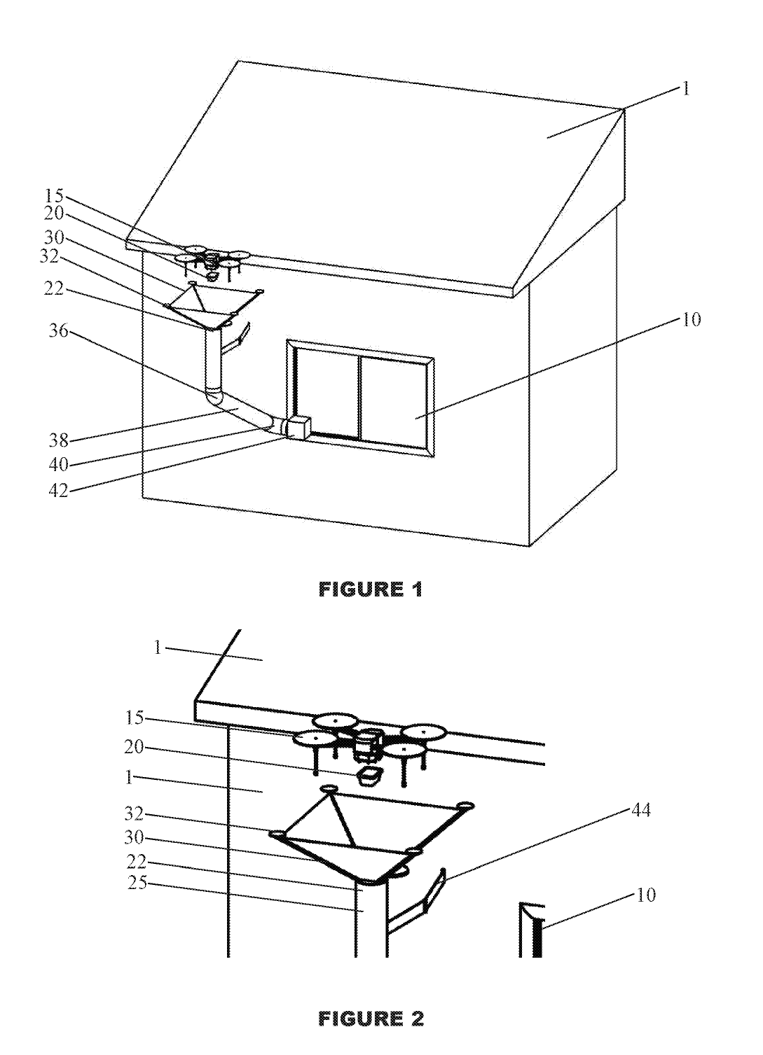

Referring to FIGS. 1 to 11, a first preferred embodiment of the invention will be described, where building 1 has window 10 to which UAV 15 can approach and deliver package 20. Building 1 is shown as a domestic home for ease of illustration. Building 1 may be any suitable building, where a person may like to have items delivered. Typically building 1 would be the home or workplace of the person. Many people now live in apartment blocks and work in offices and the invention is particularly useful for deliveries to specific locations close to other potential delivery destinations for example, individual rooms or offices. The invention is also highly useful for standalone buildings or in fact any building or address where the apparatus may be installed and it may be desired to deliver items.

Window 10 is a useful place to install extendible collection apparatus 22, for convenience of installation and access. However, it could be that other means of access to the building may be used instead, for example, a hole cut in the wall or the apparatus may be installed during construction of the building. As shown in the drawings window 10 is a standard two pane window with a slideable opening part which has been adapted to be connected to a hole formed in window 10.

Package 20 is a boxed item ordered from an online store utilising a UAV delivery system. The nature of the item within package 20, as may be imagined, could be any suitable item that can be ordered for delivery such as clothing, electrical goods, books, etcetera. The package may be sorted by size and put in a suitable size box at the warehouse. Various box sizes may be utilised suitable to carry the goods and the UAV carry mechanism adjusted accordingly.

Tube arrangement 25 of extendible collection apparatus 22 is installed outside window 10 such that a person can have package 20 delivered precisely to their home, without the need to be home at the time. Importantly, installation of extendible collection apparatus 22 is secure and sealed so that unauthorised access to the building is not in any way facilitated by the use of the apparatus.

Tube arrangement 25 may have a position for long term storage, and other positions for collection of the goods. Tube arrangement 25 moves so that collection need not occur direct at the window or wall of the abode. Instead it extends out the collection to an easier delivery point for the drone, out of the way of obstacles and then moves back towards the building for ease of collection by the person. Where a lockable container is used tube 25 moves between an extended position to collect the package from the delivery UAV to an position where the package can be dropped into a secure container. The secure container may only be then accessible from the specific building, either through a standard lock, or speciality lock such as required a mobile phone and security pin. Other forms of lock could be used instead. In this way the system is automated but maintains maximum security until the authorised person accesses the locked container. Pressure sensors or other features may be included so as to provide a visual cue as to when a package has been delivered and is ready in the box for retrieval. A similar box drop may be used as is described with reference to the second preferred embodiment of the invention.

Other considerations, such as ingress of insects or water during inclement weather have also been taken into consideration. Variation to the particular fitting of the apparatus to the building may be made to suit the needs of the use of the nature of the building, for example. In one form of the invention the tube arrangement may be omitted entirely and the item passes directly from being caught in a receptacle to a secure box arrangement. In this form of the invention the secure box itself may move between a catching position and a stored position. Use of tube arrangement 25, however, is very useful to extend the reach of the apparatus and could be used also where there are overhangs or other obstacles, which may prevent or obstruct delivery.

UAV 15 is shown as a QUADCOPTER (Trade Mark) a useful and maneuverable form of drone for package delivery. Other forms of UAV can also be used, including the large drones for delivery of heavier packages. UAV 15 includes four independently drivable motors (not labelled) and contains a power unit and control unit in communication with a mobile or other wireless network and “Global Positioning System “GPS” locating system. The particular form of instructions to UAV 15 may be varied but would be sent from a centralised control centre, or warehouse where package 20 was loaded into UAV 15. From the warehouse UAV 15 and carried package is caused to travel by controls sent to the control unit through the mobile or other wireless network and GPS system to the GPS location of where the delivery is to take place. Methods of control of UAV through the GPS are known to direct the drone to a particular location within the accuracy of the GPS location. The accuracy of the GPS is variable but may be within a metre or so. In alternative systems manual or partially manual instructions may be given to the UAV 15 to get it to the approximate location for the delivery. The standard controls of a drone or UAV can be used to move to a suitable remote location. Using the remote GPS location, the UAV is controlled to move to the approximate GPS location in a known manner. On arrival in the GPS location the inventive alignment system of the inventor is then used to verify the receptacle and align for accurate delivery—refer PCT/AU2015/000553 the contents of which is incorporated by reference.

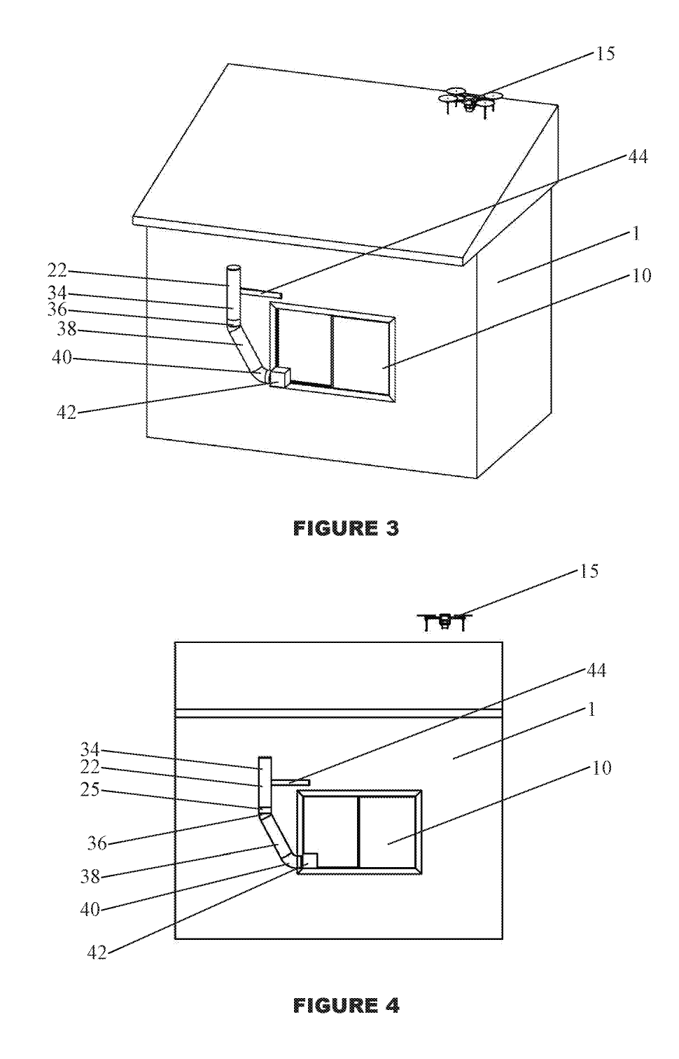

Referring to FIGS. 3 and 4, UAV 15 approaches the programmed GPS location of the building of the delivery address. Instructions for the address will include the GPS location, as well as more specific information such as the particular floor, room, height of the apparatus where delivery is to occur. Once in range the centralised controls controlling UAV 15 are added to by communication between extendible collection apparatus 22 and the internal control unit. The steps of verification, extension and alignment now commence to enable the accurate delivery.

The apparatus is identified and verified through use of identity tags (not shown) on extendible collection apparatus 22. Verification is to ensure that the correct location for delivery of the item has been located. In the given example the identity tags are barcodes along each of the four sides of the receptacle opening, readable by a sensor on UAV 15 in the usual manner. These barcodes are easily seen and checked against the records through the mobile or wireless system to ensure that the receptacle is the correct receptacle for delivery. Other tags, lights or information displays, WIFI (Trade Mark) or Bluetooth (Trade Mark) or even RFID tags with strengthened signals may be used as alternative or additional identity tags to identify the specific apparatus for delivery. Barcodes as useful as a readily recognised form of verification. It may be that the item is a valuable item such as mobile phone and so it is vital that the item is only delivered to the intended recipient. Once UAV 15 has confirmed that the apparatus is the correct apparatus for delivery, the “Verification Step”, the extension can commence.

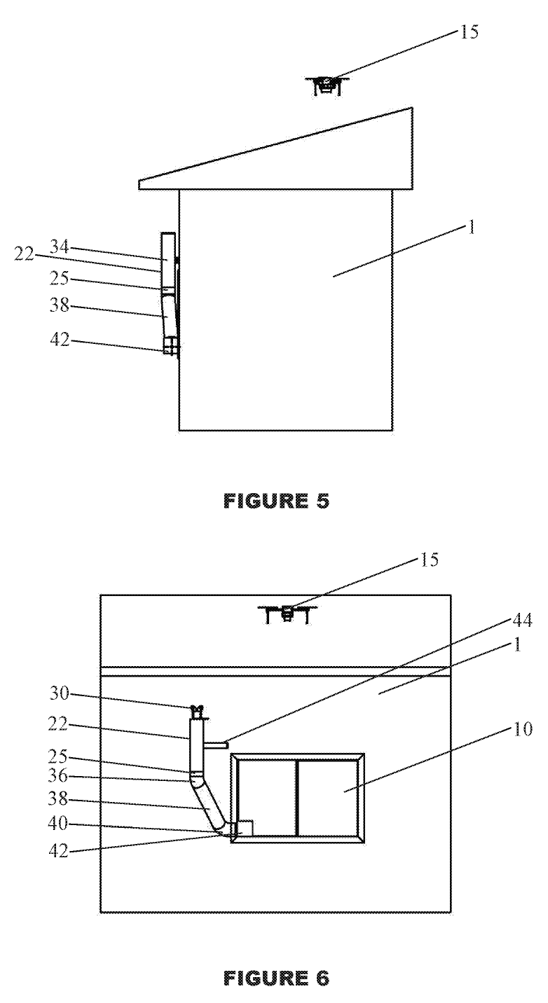

Referring to FIGS. 5 and 6, once verification has occurred a signal is sent from the control unit of UAV 15 to extendible collection apparatus to start extending. It is beneficial that extendible collection apparatus 22 is kept neatly collapsed against the wall of building 1, until it is actually needed. Once delivery is imminent then extension can start to occur to be ready to receive UAV 15 and package 20. A signal sent from the control unit on verification of being the correct apparatus causes the apparatus to start to extend out and open.

Funnel 30 is part of the extendible collection apparatus 22 which extends out from building 1 to meet and align with UAV 15, a new invention over the art. Funnel 30 as shown is a collapsible funnel made of a light-weight material such as plastic netting. Canvas or other materials may be used instead, suitable to assist to extend out from building 1 before being aligned and capturing. Funnel 30 has a square opening defined in a clear shape by location points 32, discussed further below. Other shapes could be used and defined by locating points 32 provided the control unit sensor is programmed accordingly to recognise the particular shape and use it to align and lower over the receptacle ready for delivery.

At the base of funnel 30 is an opening to tube arrangement 25. Tube arrangement 25 is the general reference to the part from funnel 30 to pass package 20 away towards building 1, ready for collection by the owner. Tube arrangement 25 is shown is adapted to be of a size to receive package 20 and for package 20 to pass under gravity away from funnel 30 toward building 1. Tube arrangement 25 includes upper part 34, elbow 36, lower part 38, joint 40 and connection point 42. As illustrated upper part 34, elbow 36 and lower part 38 are similar to drainage pipes but of a suitable size to receive package 20. The tubes are circular in cross-section and a convenient size for the purpose. Clearly, square including rectangular based tube arrangements will also be suitable. The design may be changed to suit the architecture of the building, for example.

Each of these parts works together to enable package 20 once entering funnel 20 to be passed towards building 1 and ultimately be delivered therein. Tube arrangement 25 is shown made of plastic tubing with sections 34 and 38 joined by moveably elbow 36, and joint 40 to enable the smooth moving from a contracted to an extended state. Other arrangements could be used instead.

Connection point 42 is where apparatus 22 joins building 1, as shown through window 10. Connection 42 is illustrated to enable delivery of package 20 to a secured box within the building. The secured box may only be accessed and unlocked by an authorised person. The unlocking may be by means of a mobile phone lock, key pad, or key. In each case package 20 is kept secured until the authorised person can access. In other forms of the invention connection point 42 may include a secure box, or where the area in side is secure package 20 may be simply delivered inside ready to be picked up by the person. The access to package 20 may be inside or outside of building 1. Preferably, package 20 is delivered inside building 1 can kept safe and secure until the intended recipient can access. Variations to the collection arrangement may be made to suit the needs of the user and the nature of the articles to be delivered. It is advantageous for the careful delivery of expensive electronics and the like for there to be a careful, accurate delivery of the article which can only be ultimately be accessed by the rightful owner.

Extendible bracket 44 assists to move funnel 30 with attached tube arrangement 25 between a retracted state and an extended state. Much of these controls are controlled by the control unit of UAV 15. As UAV 15 approaches the control unit and sensor verification verified the correct apparatus the control unit sends the “extend” signal to extendible collection apparatus 22. A wireless signal is sent and once in range extendible bracket 44 has actuator (not shown) activated from the closed to extended state so that extendible bracket 44 starts to swing. The movement is between a first retracted position, as seen in FIG. 3 to a fully extended position as seen in FIG. 10. A range of positions including a far extended and close extended position may be used in other forms of the invention.

As illustrated extendible bracket 44 is spring loaded in the retracted position, having resilience under tension. On receipt of the “extend” signal the tension is released outwards extends out under the action of the spring away from the building. There may be multiple controls in this regard and instead of a spring a motor could be used, or other form to move the bracket. In the given example, on the “retract” signal a motor retracts a metal cable (not shown) which winds onto a reel to retract the extendible bracket back to a retracted state.

The control unit only sends the signal once the receptacle is verified as correct for the delivery address and to that particular apparatus otherwise other apparatus would start extending needlessly. However, in other methods the signal may be emitted continuously but only on moving within range of a few metres will the actuator be activated to start the extension. The automation and specific nature of the invention is useful to enable accurate delivery of the goods without the customer having to take action. The goods are ordered and delivered and the person can collect them inside the building whenever they next are at that location.

Extendible bracket 44 is attached to tube arrangement 25 so that as it extends away from building, so does attached tube arrangement 25, smoothly winging out and away. By doing so extendible collection apparatus 22 is presented more clearly to the sensor of UAV 15 as it is clear of guttering, eaves or other parts of the building. At the same time as the signal is sent to extend extension bracket 44, funnel 30 has the open signal sent. The open signal causes opening of funnel 30, which during the un-extended state is closed for convenience, but needs to open in order to be able to align with UAV 15 to receive package 20.

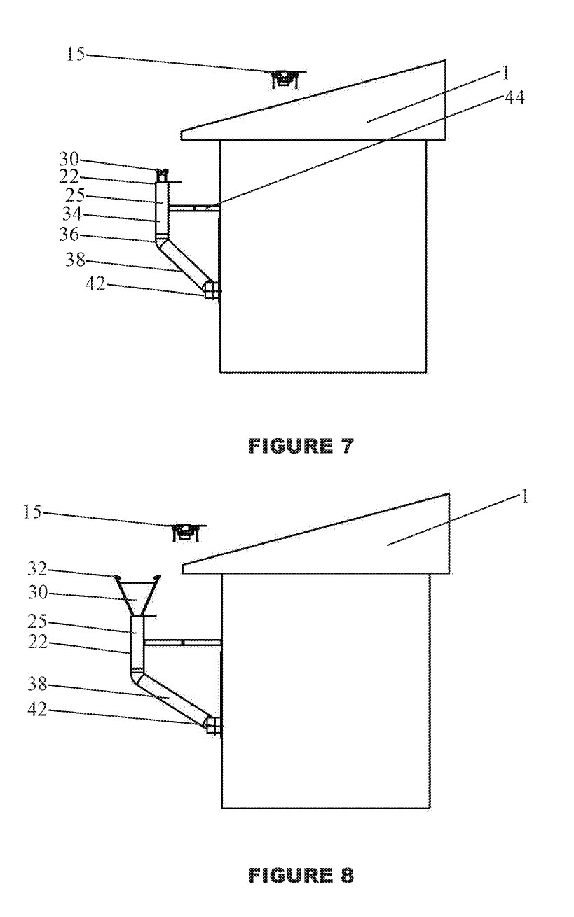

Referring to FIGS. 7 and 8, funnel 30 can be seen to be opening up to present location points 32 to UAV 15. Tube arrangement 25 has been caused to move to the extended state but could also be moving at this point. Funnel 30 as shown is similar to an inverted umbrella shape which has sides which can press together in the closed position and are caused to separate, opening funnel 30 in the extended state. UAV 15 could approach from above or from the side at this point. However, the control unit is moving UAV 15 to be near to apparatus 22 ready for the “Aligning step” which follows the extension step.

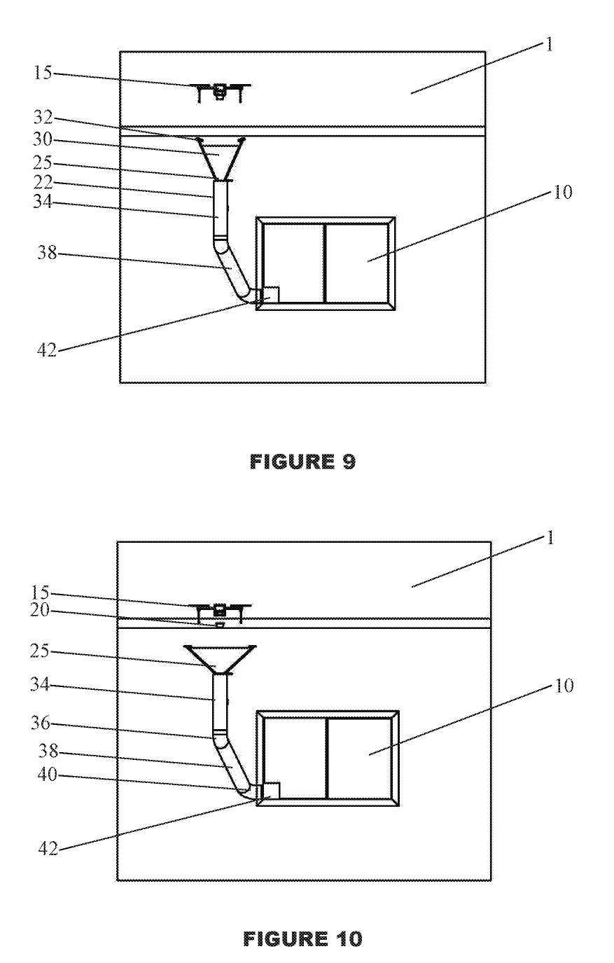

Referring to FIG. 9 in particular UAV 15 hovers directly overhead of opening funnel 30 at this stage of the delivery and can start the alignment step.

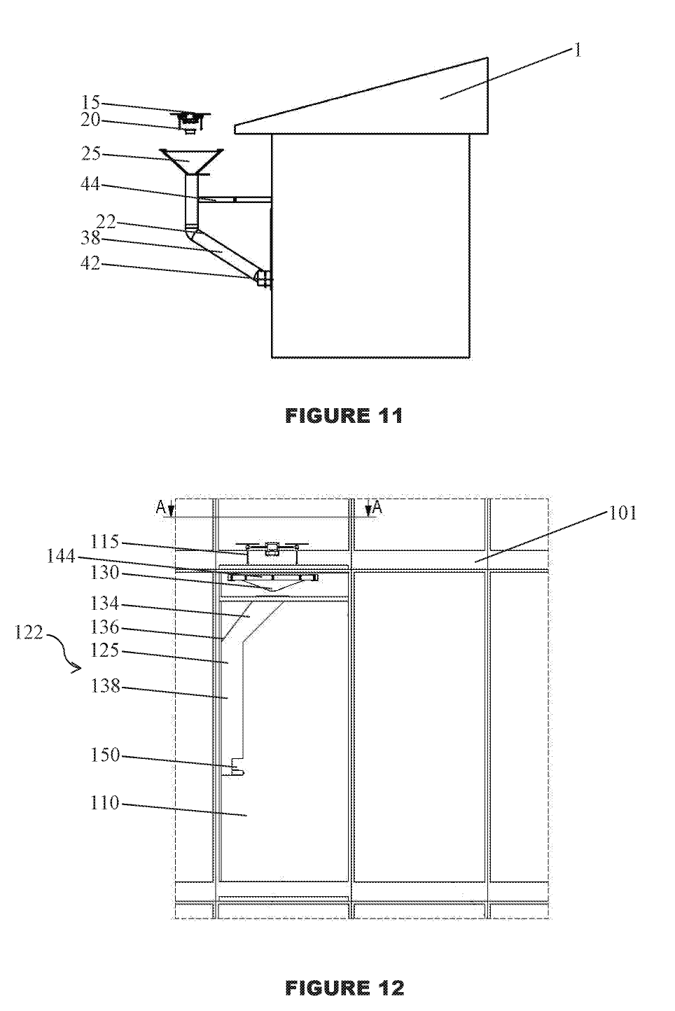

Referring to FIGS. 10 and 11 the fully extended extendible collection apparatus can be seen with tube arrangement 25 extended fully from the wall of building 1. Extendible bracket 44 is fully extended and tube arrangement 25 has swung out on extension of the bracket. Funnel 30 is fully open, ready for delivery, and forms the recognisable and defined shape by the shape formed by the location points. UAV 15 uses its internal sensor to “see” the defined shape and in response to corrections as to height and alignment sent to the control unit lowers into position to carry package 20 directly overhead of funnel 30.

Location points 32 are a further invention of the inventor of the present invention used to assist to align UAV 15 very accurately with the location where the delivery is to be made. Defining a preprogrammed shape enables the precise alignment with the receptacle and alignment directly above where the package is to be delivered. The sensor of UAV 15 is therefore able to align with the defined shape such that it is directly above. The correct receptacle has already been verified, the apparatus extended out and so the alignment can take place through use of the location points.

Once aligned, package 20 can be released, in response to the sensor determining that location points 32 as seen are forming the defined shape. The defined shape determines the height and correct alignment for package 20 to be released. Release is caused by pressure applied to either side of package 20 to be released, so package 20 falls under gravity gently into funnel 30.

Tube arrangement 30 lies directly beneath the opening (not shown) of funnel 30 so package 20 passes down and along, guided toward the building under gravity. The sloping lower part 38 aids to tip package 20 down and along to connection point 42. Connection point 42 is in communication with a box inside with a secured door by which the person can open and remove package 20.

Moving through the sequence:
FIG. 1 shows a fully open funnel 30, as UAV 15 has released the package.
FIG. 2 is a close up of this final stage of delivery to show how extendible collection apparatus 22 works at this final stage. The other FIGS. 3 to 11 illustrate each stage of the delivery process.
FIG. 3 shows as UAV 15 approaches extendible bracket 44 is close to building 1, tucked away for storage until it is needed.
FIGS. 4 and 5 as above, from different angles.
FIGS. 6 and 7, shows UAV 15 lowering towards extendible collection apparatus 44 and the signal being received to extend out from building 1, and at the same time start to open funnel 30.
FIG. 8 illustrates UAV 15 approaching as funnel 30 opens.
FIG. 9 illustrate UAV 15 positioning above the extended bracket 44 with the partially open funnel 30, and tube arrangement 25 and aligning with location points 32 and lowering further.
FIGS. 10 and 11 shows funnel 30 fully open, with the shape clearly defined as a square formed by the locating points 32 and package 20 being released.

Overall, the arrangement cleverly overcomes some issues of the art and enables a very useful delivery arrangement. Delivery by drone can occur in a fully automated manner, so that a person need not be home to receive the delivery. For example, at lunch time an item may be ordered on-line and that item will be picked, packed and delivered to the home address before the person arrives home. The item is accurately delivered to the correct receptacle, and gentle and securely delivered.

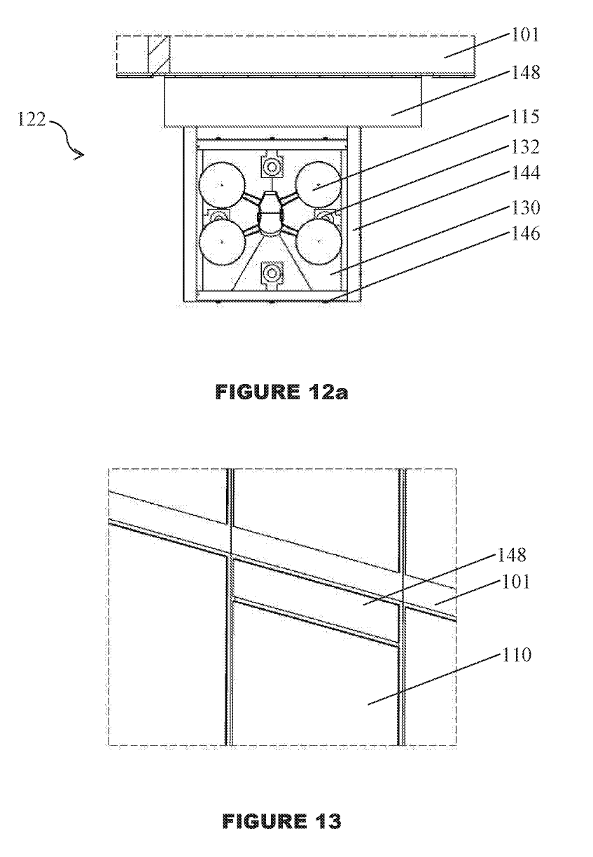

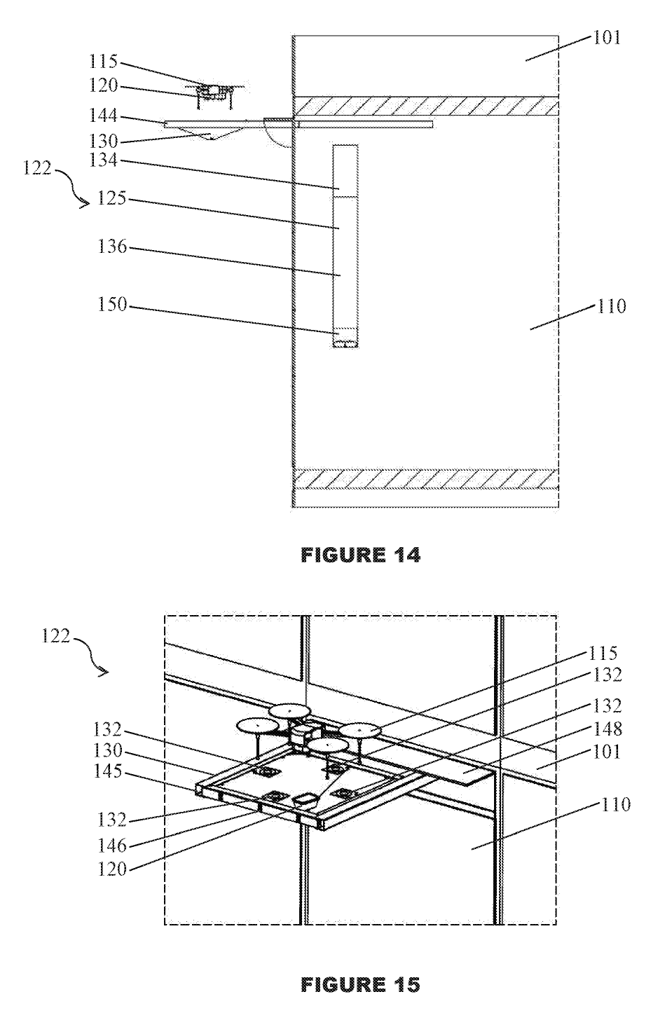

Referring to FIGS. 12, 12a and 13 to 23 a second preferred embodiment of the invention will be disclosed. In the first preferred embodiment the mechanism was fully external, and in the second preferred embodiment the mechanism is kept internal, until it is time to extend out and collect the parcel. Optionally both forms of the invention may be used for receipt of different items, on the same building.

Or alternatively, a type of apparatus may be chosen to suit the needs of different consumers. The second preferred embodiment will now be described with similar reference numerals to the first, attached to building 101, with window 110 used again as the access point for the delivered parcel. UAV 115 carries parcel 120 loaded and controlled in the same way as described above. UAV 115 is instructed to carry parcel 120 from the warehouse to the GPS location of the delivery location and controlled through use of the control unit, sensor and use of the wireless or mobile network. The delivery location is a specific GPS location, predetermined at the delivery instruction point so that UAV 115 moves to the approximate location where the delivery is to be made and received. The information of the specific address, which may include GPS, height and information or obstacles, for example, is provided by the central control or warehouse. It is this general address information which can be used to direct UAV 115 to approximately the correct address for delivery.

Extendible collection apparatus 122 is indicated generally and includes both the extending part and collection part but clearly excludes the building and UAV 15. Extendible collection apparatus 122 is again associated with window 110 or building 101 but could be set in a wall or otherwise in other forms of the invention. Similar to the first preferred embodiment tube arrangement 125 is adapted to receive package 20 on delivery. Different however is that tube arrangement 125 resides inside. Extension occurs of other parts of the apparatus to extend, collection and receive package 20 inside tube arrangement 125 as described further below.

Funnel 130 in this form of the invention is inside building 1 to give package 120 a soft guiding into tube arrangement 125. Location points again feature to assist with the alignment step before release into funnel 130 into tube arrangement 125. Tube arrangement 125 is not connected to funnel 130 as shown but is configured to be aligned in the retracted state so that dropping an item into funnel 130 enables the item to pass through the opening (not shown) through to upper part 134, elbow 136 and lower part 138 of tube arrangement 125. Tube arrangement 125 Is conveniently formed of tubes sized to receive package 120. The square based tubes could be replaced with circular based or other shapes or arrangements to receive package 20.

Extension brackets 144 and tray 145 enables extensible collection apparatus 122 to extend and receives package 120. Extension 144 is in the form of brackets, adapted to extend between a retracted state and extended state on instruction from UAV 115. Tray 145 is attached to extension brackets and moves therewith, in and out as deliveries are made and received. Identity tags 146 are included for use during the verification step to confirm with UAV 115 that delivery is to be made to the correct receiving apparatus. Flap 148 is adapted to cover the access point in building 101 for extendible collection apparatus 122 when not in use. Flap 148 can raise to enable tray 145 to be moved through use of extension brackets 144 to extend out to receive package 120 from UAV 115.

After verification, extension and alignment package 120 is released to tray 145 extended out by brackets 144 and on receipt retracted to carry package 120 inside. Once inside flap 148 closes and opening of funnel 130 opens to release package 120 in to tube arrangement 125. On release package 120 moves under gravity through upper part 134 past elbow 136 and lower part 138. Lower part 138 is a vertical part and at the base is access point 150 which catches package 120, but includes an opening to enable access. The access may be secured or as in the example shown package 120 can be removed from access point 150 directly. In other forms of the invention parts 134,136 and 138 may be varied or omitted where instead part 130 is at a height readily accessible by the person instead.

FIG. 12a shows the delivery point, with UAV 115 directly above tray 145 releasing package 120. UAV 115 has been aligned using the locating points as described for the first invention, however these are formed on tray 145 rather than funnel 30 itself. Flap 148 can also be seen in FIG. 12a fully extended while the delivery is occurring to tray 145 before the apparatus and delivered package is retracted within the building.

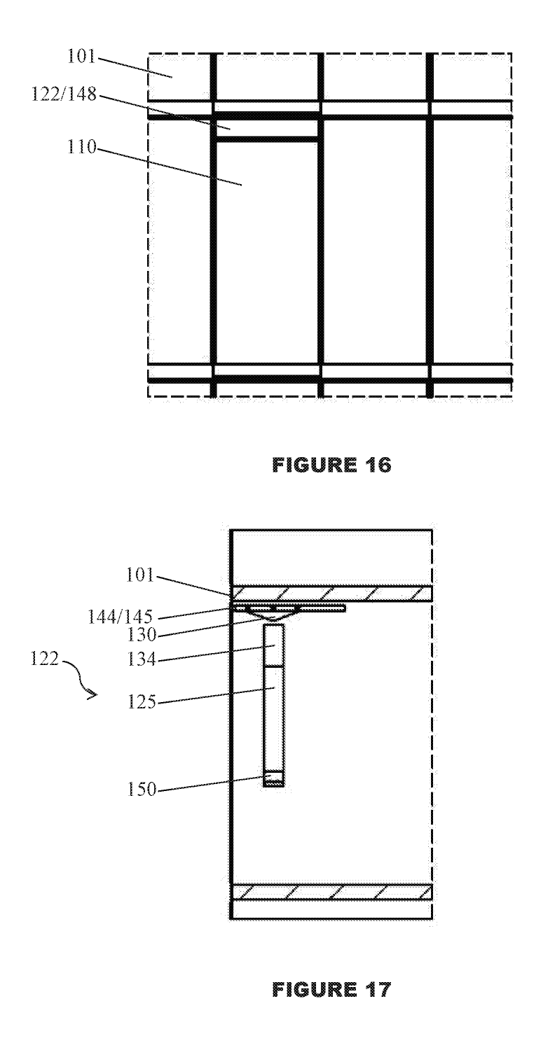

Taking the delivery through the sequence, the GPS location and generally address instructions are provided to cause UAV 115 to move towards the general GPS location. Referring to FIGS. 16 and 17, in particular UAV 115 approaches the programmed GPS location of the building of the delivery address. Instructions for the address will include the GPS location, as well as more specific information such as the particular floor, room, height of the apparatus where delivery is to occur. Once in range the centralised controls controlling UAV 115 are added to by communication between extendible collection apparatus 122 and the internal control unit. The steps of verification, extension and alignment now commence to enable the accurate delivery. At this point however, all of extendible collection apparatus 122 is internal, behind flap 148. In this way the look of building 101 is not interrupted by use of the apparatus and water, dust or dirt is kept out, and security maintained.

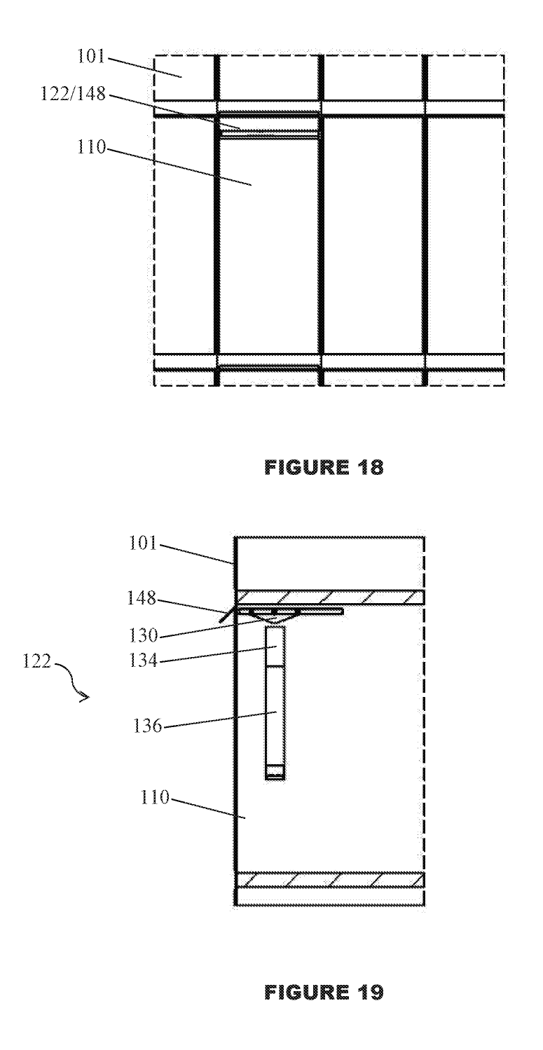

As UAV 115 approaches and at a predetermined distance a signal is received by extendible collection apparatus 122. In the illustrated example the signal is sent all the time from UAV 115 and only when UAV 115 is close enough does the signal cause action. In other forms of the invention the signal may only be sent when the GPS recognises that UAV 115 is at a predetermined close distance, say 50 metres, to the delivery point. Security and encryption of the signals may be used. In other forms of the invention a low distance signal may be omitted from the delivery apparatus itself so that when UAV 115 is sufficiently close to receive that signal a signal is sent back to extend the apparatus ready for collection of package 120. In other forms of the invention the mobile phone network may be used and internet signals to the collection part of the apparatus. Utilising Internet of Things (IoT) technology, the collection part can itself be connected to the internet and respond to an internet signal, with suitable security, when it is determined that the UAV is approaching. A variety of suitable approaches are envisaged. Flap 148 lifts ready to enable the extending parts to extend out to collect the parcel, (FIGS. 18 and 19).

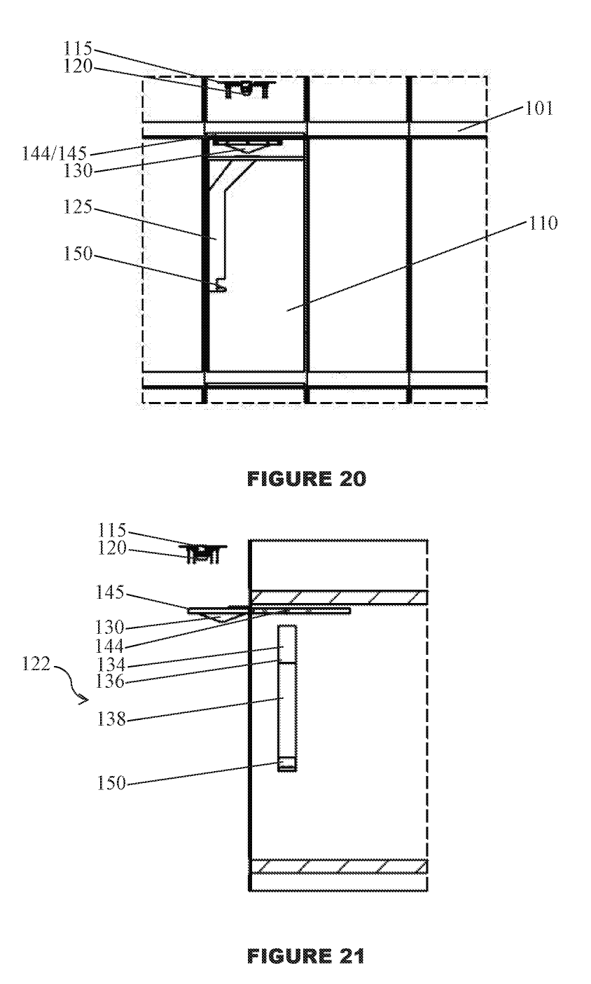

Extension now occurs of extendible brackets 144 carrying with it tray 145 through an opening created by lifting flap 148, as shown in FIGS. 20 and 21. Once fully extended UAV 115 can see tray 145 and identity tags 146. In the given example identify tags 146 are RFID tags which specifically identify the apparatus. Communicating with the control unit of UAV 115, and checking with the information provided centrally about the delivery the apparatus can be verified. Assuming the apparatus is correct the “verification step” has been completed.

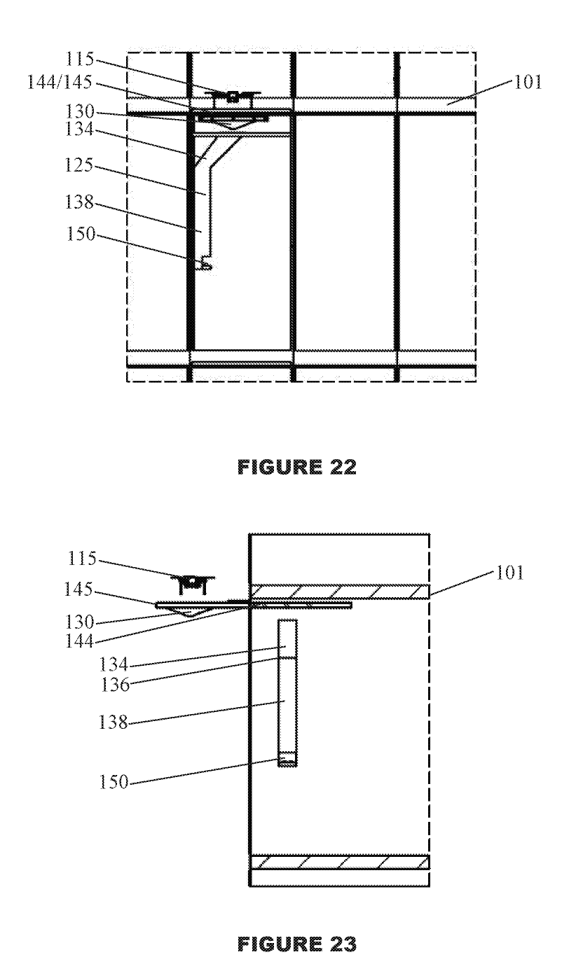

Referring to FIGS. 22 and 23 with the apparatus fully extended and verified as correct UAV 115 can align, ready for descending over trap 145. The control unit of UAV 115 once the verification step has occurred readies for the alignment step. Tray 145 has a square opening defined in a clear shape by location points 132. Alignment occurs by a sensor of UAV 115 “seeing” the defined and predetermined shape and making height calculations and adjustments accordingly. Other shapes could be used and defined by locating points 132 provided the control unit sensor is programmed accordingly to recognise the particular shape and use it to align and lower over the receptacle ready for delivery.

Each of these parts works together to enable package 120 once entering funnel 120 to be passed towards building 1 and ultimately be delivered therein. Tube arrangement 125 is shown made of plastic tubing with sections 134 and 38 joined by moveably elbow 136, and joint 140 to enable the smooth moving from a contracted to an extended state. Other arrangements could be used instead.

Overall, the arrangement cleverly overcomes some issues of the art and enables a very useful delivery arrangement. Delivery by drone can occur in a fully automated manner, so that a person need not be home to receive the delivery. For example, at lunch time an item may be ordered on-line and that item will be picked, packed and delivered to the home address before the person arrives home. The item is accurately delivered to the correct receptacle, and gentle and securely delivered. The clever invention in each of its forms is useful to receive items delivered by drone or UAV. The items are handled carefully, with precise delivery and good security and as such can include valuable items.

### REFERENCE SIGNS LIST

| | |
|---|---|
| 1 | Building |
| 10 | Window |
| 15 | UAV |
| 20 | Package |
| 22 | Extendible Collection Apparatus |
| 25 | Tube arrangement |
| 30 | Funnel |
| 32 | Locating Points |
| 34 | Upper part of 25 |
| 36 | Elbow of 25 |
| 38 | Lower part of 25 |
| 40 | Joint to 25 |
| 42 | Connection point 25/10 |
| 44 | Extendible bracket |
| 101 | Building |
| 110 | Window |
| 115 | UAV |
| 120 | Package |
| 122 | Extendible Collection Apparatus |
| 125 | Tube arrangement |
| 130 | Funnel |
| 132 | Locating Points |
| 134 | Upper part of 25 |
| 136 | Elbow of 25 |
| 138 | Lower part of 25 |
| 144 | Extendible brackets |
| 145 | Tray |
| 146 | Identity tags |
| 148 | Flap |
| 150 | Access point |

1. A collection device for items delivered by UAV, the collection device including:
a receptacle adapted to receive goods delivered by the UAV;
an extension means, adapted to extend the receptacle towards the UAV as it approaches;
wherein, as the UAV approaches the collection device for delivery of an item, the extension means approaches the UAV such that delivery is facilitated.

2. The collection device of claim 1, wherein the UAV is of a form known as a QUADCOPTER (Trade Mark).

3. The collection device of claim 1 or 2, wherein the UAV includes a power source and one or more motor to enable movement, powered by the power source.

4. The collection device according to any one of claims 1 to 3, wherein the UAV includes a control unit and it is the control unit that controls movement of the UAV.

5. The collection device of claim 4, wherein 4 the control unit may receive external signals to control the UAV through a mobile or other wireless network.

6. The collection device according to claim 4 or 5, wherein Global Positioning System “GPS” locations can be provided to the control unit to cause movement of the UAV to the GPS location.

7. The collection device according to claim 6, wherein the GPS location is predetermined at the point of arrangement of the delivery.

8. The collection device according to any one of claims 1 to 7, wherein the UAV includes a sensor and the sensor can “see” so as to be used in verification and locating steps during delivery.

9. The collection device according to any one of claims 1 to 8, wherein the UAV includes a bar code reader.

10. The collection device according to any one of claims 1 to 9, wherein the UAV includes means to detect RFID, WIFI (Trade Mark), BLUETOOTH (Trade Mark) or similar devices.

11. The collection device according to any one of claims 1 to 10, wherein the building is chosen from the group: domestic abode; commercial building; apartment block; office block; retail space; industrial building; outside location; or shed.

12. The collection device according to any one of claims 1 to 11, wherein the receptacle is adapted to receive goods ordered online.

13. The collection device according to any one of claims 1 to 12, wherein the receptacle is chosen from the following group: funnel; tray; box; basket; or net.

14. The collection device according to any one of claims 1 to 13, wherein the receptacle is part of the apparatus that first collects the item.

15. The collection device according to any one of claims 1 to 14, wherein other receptacles are included in the apparatus.

16. The collection device of claim 15, wherein other receptacles are included to receive an item temporarily.

17. The collection device according to any one of claims 1 to 16, wherein a secure container is included, in which the item is stored after delivery until collection.

18. The collection device of claim 17, wherein the secure container is extendible.

19. The collection device of claim 17 or 18, wherein the secure container forms part of the receptacle.

20. The collection device according to any one of claims 17 to 19, wherein the secure container is fixed in place.

21. The collection device according to any one of claims 17 to 20, wherein the secured container is inside the building.

22. The collection device according to any one of claims 17 to 21, wherein the security includes an electronic lock.

23. The collection device of claim 22, wherein the electronic lock is controlled by use of a mobile phone.

24. The collection device of claim 23, wherein the security software is used with a pin or card access to securely access the inside of the secure container and retrieve the item.

25. The collection device according to any one of claims 1 to 24, wherein the receptacle includes a funnel.

26. The collection device of claim 27, wherein the funnel includes an opening and the goods pass under gravity towards the opening during delivery.

27. The collection device of claim 25 or 26, wherein the funnel is collapsible.

28. The collection device of according to any one of claims 25 to 27, wherein the funnel is made of a soft material.

29. The collection device of according to any one of claims 25 to 28, wherein the funnel is moveable between an open and a closed state.

30. The collection device of claim 29, wherein the funnel may lie vertical against the wall in the retracted state and extend out to receive an item, to lie substantially horizontal.

31. The collection device of according to any one of claims 25 to 30, wherein the funnel opens out from a retracted to an open state on actuation by a signal from the control unit of the UAV or via the mobile phone or other wireless network.

32. The collection device of according to any one of claims 25 to 31, wherein the funnel may unfold or unfurl during extension.

33. The collection device of according to any one of claims 1 to 32, wherein an extendible tube arrangement is included to assist to move the item from the point of receipt to a collection point.

34. The collection device of claim 33, wherein the collection point is a secure container.

35. The collection device of claim 34, wherein the collection point is the secure container of any one of claims 16 to 24.

36. The collection device of according to any one of claims 1 to 35, wherein one or more brackets are included and these are moveable between an open and closed state.

37. The collection device of claim 36, wherein the brackets are moveable between an open and closed state, on actuation by a signal from the control unit of the UAV or via the mobile phone or other wireless network.

38. The collection device of claim 36 or 37, wherein the bracket includes a spring under tension in the closed state and on activation the spring is released to extend out from the building.

39. The collection device according to any one of claims 36 to 38, wherein the bracket includes a motorised arm.

40. The collection device according to any one of claims 1 to 39, wherein identity means are included to identify the specific apparatus for delivery.

41. The collection device according to any one of claims 1 to 40, wherein the receptacle include identity means or tags so the address of the order can be verified, before the delivery proceeds further.

42. The collection device of claim 41, wherein the identity tags are chosen from the group: bar codes; lights; LEDs; RFIDs; BLUETOOTH (Trade Mark) or other signally devices.

43. The collection device according to any one of claims 1 to 42, wherein location means are included.

44. The collection device of claim 43, wherein the location means are included on or about the receptacle.

45. The collection device of claim 43 or 44, wherein the locating means define a specific shape, a location for receipt of the goods.

46. The collection device according to any one of claims 43 to 45, wherein the location means are chosen from the following group: RFIDs; LEDs; sounds; and or light sequences.

47. The collection device according to any one of claims 43 to 46, wherein the location means can communicate with the control unit to assist to locate and align the UAV for delivery of the goods.

48. The collection device according to any one of claims 1 to 47, wherein the extension is to rotate through 90 degrees from a vertical to horizontal plane.

49. The collection device according to any one of claims 1 to 48, wherein as the UAV approaches the building the extension means is caused to extend from the building.

50. A collection apparatus for items delivered by UAV, the collection device being associated with a building and including:
a receptacle adapted to receive goods delivered by the UAV;
an extension means, connected to the building and adapted to extend the receptacle from the building towards the UAV;
wherein, the apparatus can remain proximal to the building when not in use and extend toward the UAV to facilitate delivery of the item.

51. A collection device for items delivered by UAV the collection device including:
an extension means, adapted to extend towards the UAV as it approaches, wherein, as the UAV approaches the collection device for delivery of an item, the extension means approaches the UAV to collect the item.

52. A method of use of an extendible collection device including a receptacle adapted to receive goods delivered by UAV, and an extension means, connected to the building at the delivery address and adapted to extend the receptacle from the building towards the UAV for UAV delivered goods, the method including the following steps:—
a) Moving the UAV to the general location of the delivery address;
b) Identifying the receptacle is the correct address for delivery;
c) Extending the receptacle away from the building;
d) Locating the extended receptacle;
e) Aligning the UAV directly above the receptacle;
f) Releasing the package.

53. The method of claim 52 wherein the collection apparatus is the collection apparatus of any one of claims 1 to 51.
